(19) United States
(12) Patent Application Publication
(10) Pub. No.: US 2006/0092286 A1
(43) Pub. Date: May 4, 2006

(54) Remote operation of wireless telescope over a network

(76) Inventors: Ravindra V. Velhal, Beaverton, OR (US); Jeetendra G. Deshmukh, Portland, OR (US); Nikhil M. Deshpande, Beaverton, OR (US)

Correspondence Address: TROP PRUNER & HU, PC, 8554 KATY FREEWAY, SUITE 100, HOUSTON, TX, 77024, US

(21) Appl. No.: 10/980,014

(22) Filed: Nov. 3, 2004

(51) Int. Cl. H04N 5/232; H04N 5/225; G21K 7/00; G01C 5/00; G02B 5/08; G02B 7/182

(52) U.S. Cl. 348/211.3; 348/207.1; 378/43; 33/292

(57) ABSTRACT

Telescopes may be accessible and may be controlled by users around the world. Those users may communicate with network stations over a peer-to-peer network. The network station, in turn, may communicate with the telescope over a wireless interface. In this way, remote control over the telescope may be achieved by a variety of users around the world.

### BACKGROUND

This invention relates generally to telescopes.

A person interested in a given celestial event may want to view the event from a number of different geographic areas. When these vantage points are widely separated, and the event is relatively short in duration, this may not be possible. In addition, the weather may permit viewing in only a few locations at particular times. If the weather is sufficiently unpredictable then the person may have difficulty deciding which site to visit to view the celestial event.

Since celestial events can only be viewed at night, no opportunity exists to view events during the day. The viewer needs to be located at the telescope, and the telescope needs to be at the right location, at the right time, with the right weather, and surrounding lighting. These requirements tend to limit viewing opportunities.

Thus, there is a need for better ways to increase the opportunities for viewing celestial events.

### BRIEF DESCRIPTION OF THE DRAWINGS

FIG. 1 is a depiction of a system in accordance with one embodiment of the present invention;

FIG. 2 is a flow chart for software in accordance with one embodiment of the present invention.

FIG. 3 is a flow chart for software in accordance with another embodiment of the present invention.

### DETAILED DESCRIPTION

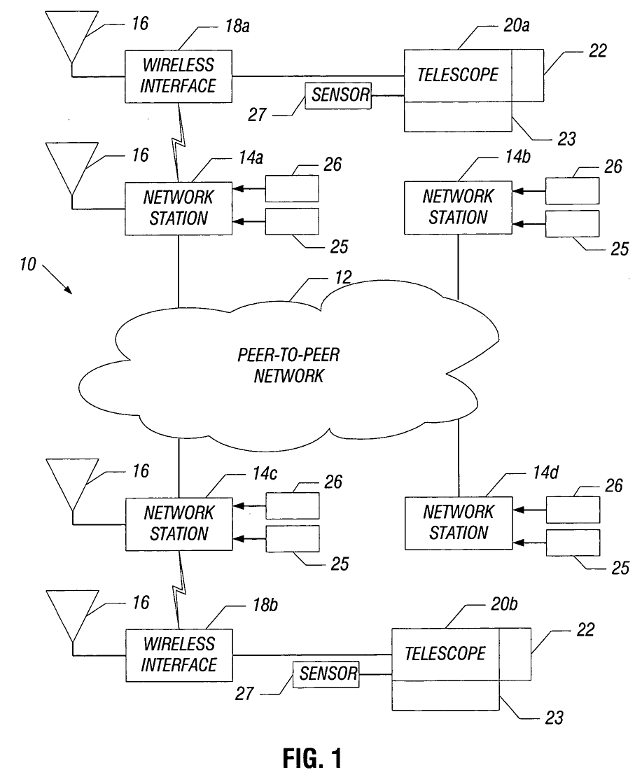

Referring to FIG. 1, a number of network stations 14a-14d may be distributed around the world. Each network station 14 may be associated with a telescope 20 or not. A network station 14 may simply be any processor-based system with access to the peer-to-peer network 12. Thus, a variety of network stations 14a may communicate over the network 12. Users at network stations 14b and 14d are without a telescope in this example. Users at network stations 14a and 14c have co-located telescopes 20a and 20b, respectively.

The telescopes 20 may be equipped with digital cameras 22 and are provided with servo controls 23 to permit automatic telescope positioning and focusing. Thus, the telescopes may be electronically aligned to enable viewing of a celestial event, via the servo controls 23. That event may be captured by the digital cameras 22.

The telescopes 20 may also be equipped with sensors 27 to manage the telescope 20. The sensors 27 may include one or more motion sensors, position sensors such as global positioning satellite sensors, light sensors, temperature sensors, wind sensors and proximity sensors.

In some cases, the network station 14a or 14c may still be some distance from a telescope 20a and 20b. A wireless interface 18a or 18b, associated with the telescopes 20a and 20b, enables the network station 14c to communicate wirelessly with the associated wireless interface 18. Each station 14 and each interface 18 may have an antenna 16 to permit wireless communications over an appropriate wireless protocol, including Bluetooth (See Bluetooth Specification, V.l.02, 25 Aug. 2003), 802.11 (IEEE Std. 802.11-1997, IEEE New York, N.Y.), cellular communications and WiMax (IEEE 802.16). Other wireless communication technologies may also be used.

Each wireless interface 18 is capable of receiving a wireless signal to transmit instructions to the telescope 20a from the network station 14, associated therewith, and to receive images from the telescope 20a and to transmit them to the network station 14 associated with the interface 18. From the network station 14, such as the station 14a or 14c, telescope orientation and image capture instructions can be received from anywhere, over the network 12, including from the network stations 14b and 14d. Likewise, the resulting images obtained as a result of those instructions can be communicated over the peer-to-peer network 12 to and from anywhere in the world.

In other words, a telescope 20 may be remotely aimed via the interface 18 and the servo control 23. The resulting imaged scene may be captured by the digital camera 22 and wirelessly conveyed to a proximate station 14.

Each of the network stations 14 may have file sharing software 25 stored thereon. The software 25 helps in establishing the peer-to-peer connections, performing image tracking, and programming itself for specific celestial events. For example, users may program the system to watch or record Venus on a specific date at a specific time and to store the images at specific intervals or to record streaming data, as examples. Recorded images may be played back at a later time. The same software 25 may add better intelligence to the telescope 20a or 20b. The software 25 may also be capable of accepting incoming authenticated peer to peer connections and managing and coordinating various requests for telescope control as appropriate via a token-based mechanism or similar techniques. The software 25 may also calibrate the telescope 20.

For example, if someone from New York wants to view a celestial event that is happening in Australia, the software 25 may allow authenticated access to a registered user to control the wireless telescope in Australia, enabling that telescope to track events of interest to the user in New York. The software 25 may also stream live image feed of the celestial event being tracked to the requesting user and other registered users on the peer to peer network 12.

Registered peer-to-peer users across the globe, with or without telescopes, can view images of celestial events in real time, but may also control and track the wireless telescopes 20a and 20b. The user can view the celestial event and control the telescope in real time even though the telescope is in another part of the world. Thus, peer-to-peer users do not have to miss the celestial event due to bad weather, location of the celestial event, or other constraints. A telescope can track meteorite showers happening in Africa under control from the United States, as one example.

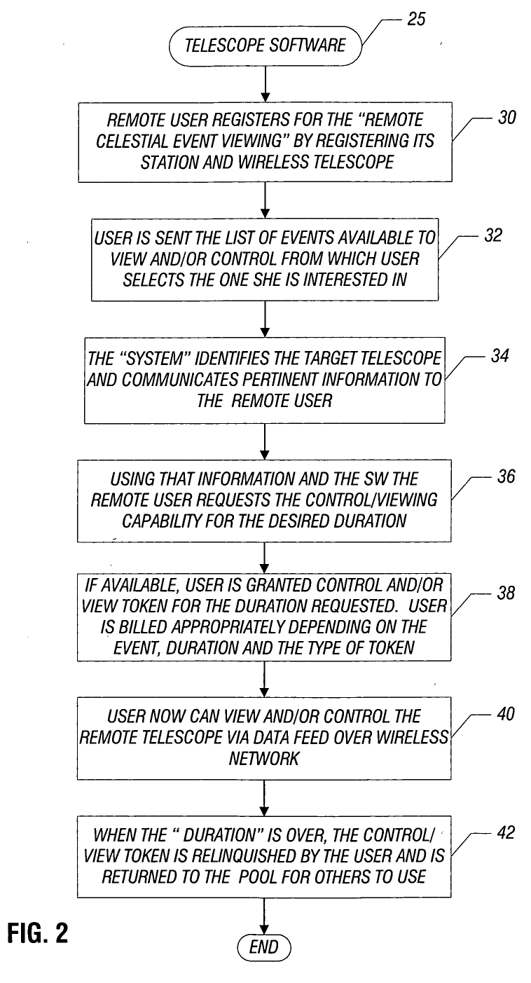

Referring to FIG. 2, the software 25 enables remote users to register for the remote celestial event viewing by registering its station 14 and wireless telescope 20 as indicated in block 30. That user is sent a list of events (block 32) available to view and/or control from which user selects the one she is interested in. The peer-to-peer system 10 identifies the target telescope, such as the telescope 20a or 20b, and communicates pertinent information to the remote user as indicated in block 34.

Using that information and the peer to peer software 25, the remote user requests the control viewing capability for a desired duration as indicated in block 36. If available, the user is granted control and/or a viewing token for the duration requested. The user is then billed appropriately, depending on the event, duration, and type of token, as indicated in block 38.

Now the user can view and/or control the remote telescope 20 via a data feed over the wireless peer to peer network 12 as indicated in block 40. When the duration of the assigned use is over, the control or viewing token is relinquished by the user and is returned to the pool for use by others as indicated in block 42.

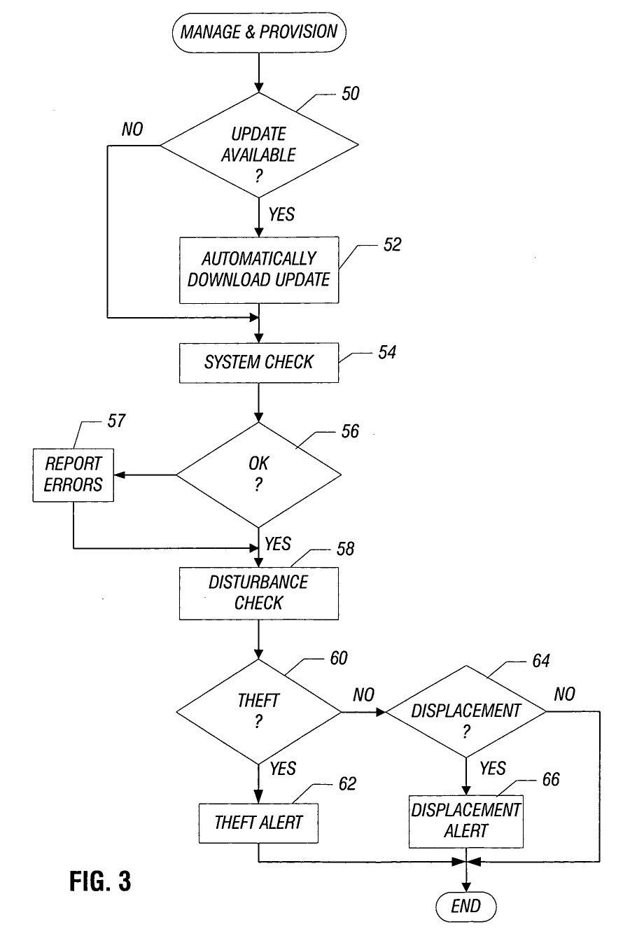

Referring to FIG. 3, management and provisioning software 26 may be included as a separate software package or may be provided as part of the software 25. Initially a check at diamond 50 indicates whether any software updates are available for the software 25. If so, those updates may be automatically downloaded to every station 14 on network 12 as indicated in block 52.

Next a system check 54 may be conducted. The system check 54 may check the operability of each station 14 as well as the operability of each telescope 20. Each telescope 20 may be periodically called upon to implement a number of different commands. If the telescope adequately performs those commands as determined at diamond 56, the telescope passes. Otherwise errors may be reported to the system administrator as indicated in block 57.

Next a check at diamond 58 may indicate whether or not the telescope 20 has been disturbed. If so a check at diamond 60 determines whether a theft has occurred. For example if the position sensors associated with the telescope 20 indicate that the telescope has been moved a significantly different location, a theft alert 62 may be issued. Conversely if the telescope has only been displaced, as determined in diamond 64, a displacement alert 66 may be issued. For example the telescope may be knocked over or may be inadvertently bumped and moved out of position.

In this way the telescope may not only be operated remotely, and viewed remotely, but may also be managed and provisioned remotely in some embodiments.

Through the use of a wireless telescope, one may operate an outdoor telescope from within a shelter or other protected environment. Using a peer-to-peer network, access to telescopes may be restricted to trusted users in some embodiments. In addition, the way that those users access telescopes of other people may be controlled and prioritized to reduce misuse in some embodiments.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. a method comprising:
enabling communication between a remote user and a telescope over a network; and
providing a network station to communicate with said network and to communicate with said telescope over a wireless interface.

2. The method of claim 1 including enabling the remote user to reposition the telescope by sending commands over a peer-to-peer network.

3. The method of claim 2 including enabling the remote user to receive images from said telescope over said peer-to-peer network.

4. The method of claim 1 including operating said telescope remotely over a wireless interface.

5. The method of claim 2 including controlling access to said peer-to-peer network.

6. The method of claim 5 including billing for access to said peer-to-peer network.

7. A telescope comprising:
a digital camera coupled to said telescope to capture images from said telescope;
a wireless interface to enable said telescope to be oriented remotely and to receive images from said camera;
a servo control, coupled to said interface, to orient said telescope; and
a sensor coupled to said interface, to enable said telescope to be managed remotely.

8. The telescope of claim 7 including a station, said station storing software to enable remote control of said telescope through said wireless interface.

9. The telescope of claim 8, said station to receive remote commands to reposition said telescope.

10. The telescope of claim 8 to transmit images captured by said digital camera through said wireless interface to said station.

11. The telescope of claim 7 wherein said sensor is selected from the group including a position sensor, a temperature sensor, a light sensor, a wind sensor, a motion sensor and a proximity sensor.

12. An article comprising a medium storing instructions that, if executed, enable a processor-based system to:
enable communication between a remote user and a telescope over a peer-to-peer network;
convey images from said telescope over said peer-to-peer network; and
receive telescope positioning commands over said peer-to-peer network and convey them to said telescope over a wireless interface to control the position of said telescope.

13. The article of claim 12 further storing instructions that, if executed, enable a remote user to reposition the telescope by sending commands over said peer-to-peer network.

14. The article of claim 13 further storing instructions that, if executed, enable the remote user to receive images from said telescope over said peer-to-peer network.

15. The article of claim 12 further storing instructions that, if executed, enable the remote user to control access to said peer-to-peer network.

16. The article of claim 15 further storing instructions that, if executed, enable billing for access to said peer-to-peer network.

17. The article of claim 12 further storing instructions that, if executed, enable registering users to view an event.

18. The article of claim 12 further storing instructions that, if executed, enable scheduling access to the telescope.

19. The article of claim 12 further storing instructions that, if executed, enable granting exclusive access to a telescope via a token for a given period.

20. The article of claim 19 further storing instructions that, if executed, enable automatically revoking the token at the end of a predetermined time period.

21. A system comprising:
a processor-based device; and
a storage associated with said processor-based device storing instructions to enable said device to receive images over a peer-to-peer network from a telescope, provide telescope positioning commands over said peer-to-peer network to said telescope using a wireless interface, and to remotely manage and provision said telescope.

22. The system of claim 21 including a station, said station storing software to enable remote control of said telescope through said wireless interface.

23. The system of claim 22, said station to receive remote commands to reposition said telescope.

24. The system of claim 22 to transmit images captured by said digital camera through said wireless interface to said station.

25. The system of claim 21 further storing instructions that, if executed, enable scheduling access to the telescope.

26. The system of claim 21 further storing instructions that, if executed, enable granting exclusive access to a telescope via a token for a given period.

27. The system of claim 21 wherein said storage stores instructions to automatically implement software updates.

28. The system of claim 21 wherein said storage stores instructions to remotely monitor telescope performance.

29. The system of claim 20 wherein said storage stores instructions to remotely determine if said telescope has been disturbed.

30. The system of claim 29 wherein said storage storing instructions to determine if said telescope has been stolen.
